(19) United States
(12) Patent Application Publication
(10) Pub. No.: US 2013/0319122 A1
(43) Pub. Date: Dec. 5, 2013

(54) LASER-BASED EDGE DETECTION

(71) Applicant: Bogdan I. Epureanu, Ypsilanti, MI (US)

(72) Inventor: Bogdan I. Epureanu, Ypsilanti, MI (US)

(73) Assignee: THE REGENTS OF THE UNIVERSITY OF MICHIGAN, Ann Arbor, MI (US)

(21) Appl. No.: 13/907,272

(22) Filed: May 31, 2013

Related U.S. Application Data
(60) Provisional application No. 61/653,470, filed on May 31, 2012.

(51) Int. Cl. G01B 11/14

(52) U.S. Cl. CPC G01B 11/14
USPC 73/655; 356/72

(57) ABSTRACT

A system to detect an edge of an object includes an optical instrument configured to direct a laser beam toward the object, configured to receive a reflection of the laser beam based on whether the laser beam impacts the object, and configured to generate an intensity output indicative of an intensity of the reflection, a positioning system configured to position the object in a location relative to the optical instrument, the positioning system including a position sensor to provide a position output indicative of the location, and a processor configured to determine a position of the edge of the object based on the intensity output and the position output.

### CROSS-REFERENCE TO RELATED APPLICATION

This application claims the benefit of U.S. provisional application entitled “Laser-Based Edge Detection,” filed May 31, 2012, and assigned Ser. No. 61/653,470, the entire disclosure of which is hereby incorporated by reference.

### BACKGROUND OF THE DISCLOSURE

1. Field of the Disclosure

The disclosure relates generally to vibration testing.

2. Brief Description of Related Technology

Vibration testing of an object typically involves measuring a vibration response to an excitation force. The excitation force is often applied in a non-contact manner to avoid influencing the vibration response. The vibration response is likewise also typically measured in a non-contact manner One non-contact technique for measuring the vibration response involves a laser vibrometer. Laser vibrometers use interferometry to capture low and high frequency vibratory movement (e.g., from about 10 Hz to about 100 kHz and higher).

Most non-contact vibration testing involves accurate relative positioning of the object and the measurement apparatus. The vibration response of an object often varies between different positions on the object. The variance may be substantial when measuring higher vibration modes. It is thus useful to know the location of the point on the object at which the vibration measurements are being made. The position of the measured point is often expressed relative to the geometry (e.g., edges) of the vibrating object.

The accuracy of vibrometer-based vibration testing systems may accordingly depend upon knowledge of the position of the measurement. Calibrating the measurements in connection with the reference system of the vibrometer is often undesirably inaccurate. Positioning accuracy for the vibrometer may be insufficient for a number of reasons. For example, a small error in orienting the laser beam of the vibrometer may be magnified over the distance from the vibrometer to the object. An error on the order of microns in the optics of the vibrometer may thus lead to a measurement offset on the order of a millimeter. Unfortunately, offsets of that size or smaller may be problematic during the measurement of complex mode shapes or high order vibration modes.

### SUMMARY OF THE DISCLOSURE

In accordance with one aspect of the disclosure, a system to detect an edge of an object includes an optical instrument configured to direct a laser beam toward the object, configured to receive a reflection of the laser beam based on whether the laser beam impacts the object, and configured to generate an intensity output indicative of an intensity of the reflection, a positioning system configured to position the object in a location relative to the optical instrument, the positioning system including a position sensor to provide a position output indicative of the location, and a processor configured to determine a position of the edge of the object based on the intensity output and the position output.

The intensity output may be indicative of the reflection of the laser beam off of a reflective surface of the object. Alternatively, the intensity output is indicative of the reflection of the laser beam off of a reflective surface of a mask configured for placement along the edge of the object. The system may alternatively or additionally include a shield configured to absorb the laser beam and for placement along the edge of the object.

The processor may be configured to implement an edge detection procedure. The edge detection procedure may be configured to detect an abrupt change in the intensity of the reflection of the laser beam. The edge detection procedure may include a curve fitting procedure. Alternatively or additionally, the edge detection procedure is configured with a calibration-based reference intensity level. Alternatively or additionally, the edge detection procedure is configured with a calibration-based time delay correction factor.

In some embodiments, the system further includes an excitation system configured to apply an excitation force to the object to produce a vibration response in the object. The optical instrument may include a vibrometer configured to measure the vibration response.

The positioning system may include linear and rotary stages to adjust the location.

The optical instrument may include a vibrometer to receive the reflection of the beam.

In accordance with another aspect of the disclosure, a method of detecting an edge of an object includes directing a laser beam generated by an optical instrument toward the object, adjusting a position of the object relative to the optical instrument to scan the object with the laser beam, detecting an intensity of a reflection of the laser beam, and determining the edge of the object based on the detected intensity and the adjusted position.

The method may further include positioning a mask along the edge of the object.

Determining the edge may include implementing an edge detection procedure. The edge detection procedure may be configured to detect an abrupt change in the intensity of the reflection of the laser beam.

In some embodiments, implementing the edge detection procedure includes executing a local fitting algorithm. The method may further include calibrating the edge detection procedure with a reference intensity level. The method may further include calibrating the edge detection procedure with a time delay correction factor.

The method may further include applying an excitation force to the object, and measuring a vibration response to the excitation force with the laser vibrometer at a measurement position on the object based on the determined edge.

Adjusting the position of the object may include displacing the object with a linear stage or a rotary stage. The method may further include sensing a displacement of the linear stage or the rotary stage to generate an indication of the position of the object.

### BRIEF DESCRIPTION OF THE DRAWING FIGURES

For a more complete understanding of the disclosure, reference is made to the following detailed description and accompanying drawing figures, in which like reference numerals identify like elements in the figures.

FIG. 1 is a schematic diagram of a system configured to detect the position of an edge of an object in accordance with one embodiment.

FIG. 2 is a flow diagram of a vibrometer-based method of edge detection in accordance with one embodiment.

FIG. 3 is a graphical plot depicting a curve fitting procedure for determining the position of an edge based on intensity measurements provided by the disclosed methods and systems.

FIG. 4 is a graphical plot of an exemplary application of the disclosed methods and systems to depict the detection of an edge of a bladed disk at several different scan speeds.

FIG. 5 is a graphical plot of an exemplary time delay correction factor for use in the disclosed methods and systems in accordance with one embodiment.

FIG. 6 is a graphical plot of a grid of scan locations for a test structure.

FIG. 7 is a graphical plot of the resolution or sensitivity of the disclosed methods and systems for varying test structure thicknesses.

FIGS. 8A and 8B are graphical plots of average edge location and standard deviation, respectively, for a given scan time or speed.

FIG. 9 is a graphical plot of shifts in detected edge location as a function of scan speed.

FIG. 10 is a graphical plot of compensated edge locations to depict the repeatability of the edge detection of the disclosed embodiments.

FIG. 11 is a graphical plot of average edge location as a function of scan set size.

FIG. 12 is a graphical plot of detected edge location as a function of laser focus level and the diameter of the laser beam.

FIGS. 13A-13F are graphical plots depicting statistical distributions of detected edge locations for varying scan rates.

FIGS. 14A-14C are graphical plots depicting statistical distributions of detected edge locations for varying laser focus levels.

FIGS. 15A and 15B are graphical plots depicting statistical distributions of detected edge locations without the benefit of a mask.

While the disclosed systems and methods are susceptible of embodiments in various forms, specific embodiments are illustrated in the drawing figures (and will hereafter be described), with the understanding that the disclosure is intended to be illustrative, and is not intended to limit the invention to the specific embodiments described and illustrated herein.

### DETAILED DESCRIPTION OF THE DISCLOSURE

Systems and methods of laser-based edge detection are described. Knowledge of edge position may be useful in connection with vibration and other testing of objects to which an excitation or other test force is applied. The edge of an object is detected in the disclosed systems and methods via an optical instrument such as a laser vibrometer. The disclosed embodiments may use the variations in measurements in the laser intensity signal to determine or detect the edge of the object.

The laser vibrometer may also be used to measure a vibration response to excitation. The laser vibrometer may be used for both vibration response measurement and positioning of the vibration response measurement. With the position of the edge known, a vibration measurement position may be accurately selected. For example, it may be useful to obtain vibration measurements on each blade of a bladed disk at a certain distance from the leading edge and a certain distance from the blade tip. With the disclosed systems and methods, vibration at that position may be consistently measured across a number of blades, regardless of non-uniformities in the placement or other characteristics of the blades.

Use of the same equipment, i.e., the laser vibrometer, to position and take the measurement may remove a potential source of positioning error from the system. There is one less device or system to reference to a common coordinate system and, thus, one less source of error or inaccuracy. Any inaccuracies introduced via the optics or other components of the laser vibrometer are taken into account during the edge detection procedure. Any subsequent positioning of the object is accordingly unaffected by such inaccuracies. The disclosed embodiments may thus address the challenge presented by vibration testing involving finding the edges of a test structure relative to the coordinates of the measuring system.

Although described in connection with turbomachinery, such as bladed disks, the disclosed methods and systems are well-suited for vibration and other testing involving a wide variety of objects and structures. For example, the disclosed systems and methods may be used for vibration testing of test structures, such as auto body parts and components of aerospace or aeronautical structures. The disclosed systems and methods may also be applied in a wide variety of test contexts. The disclosed embodiments are not limited to the vibration response context. For example, the disclosed systems and methods may be used to support various testing procedures in which knowledge of the geometry of the test object or structure is useful. For instance, the disclosed edge detection techniques may be useful for locating the center of a disc-shaped (but slightly nonconcentric) object.

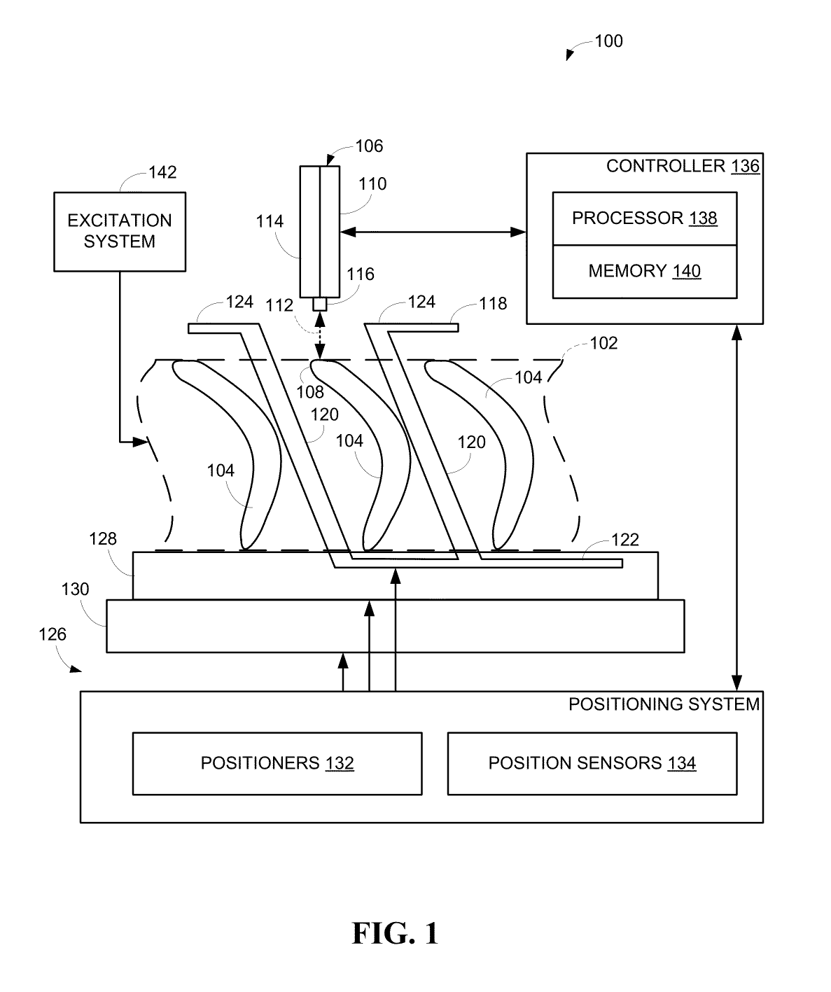

FIG. 1 depicts an example of a system 100 constructed in accordance with one embodiment. The system 100 is configured to determine one or more edge positions or locations for an object 102 or other test structure. In this example, the object 102 is a bladed disk having a number of blades 104. The system 100 includes a laser vibrometer 106 or other optical instrument to detect the position of an edge 108 of one of the blades 104. The laser vibrometer 106 includes a laser source 110 configured to generate a laser beam 112. As described below, the position of the edge 108 is determined based on the reflection of the laser beam 112. The laser vibrometer 106 further includes a sensor 114 to generate an output representative of the intensity of the reflection of the laser beam 112. One suitable vibrometer is the Compact Laser Vibrometer model number CLV-2534 commercially available from PolyTec Inc. (Irvine, Calif.). Other laser vibrometers may be used.

The laser vibrometer 106 may include one or more optical components, such as mirrors, lenses, and/or other components, to direct the laser beam 112 toward the edge 108 of one of the blades 104 of the object 102. The laser beam 112 may be focused to a desired width or diameter by the source 110 and/or other component of the laser vibrometer 106 and/or other optical instrumentation. For example, the laser beam 112 may be focused via a lens or aperture 116 (or other laser vibrometer head) through which the laser beam 112 is directed. The diameter may be selected to provide a desired level of accuracy, as described below. A variety of optical instruments may be used. The optical components or instruments may be integrated with the laser vibrometer 106 to any desired extent.

The laser vibrometer 106 may be configured to receive a reflection of the laser beam. The laser vibrometer 106 may include various mirrors and/or other optical components for redirecting the beam or the reflection to generate an interferometric measurement. In this example, the laser vibrometer 106 receives the reflection via the aperture 116. In other embodiments, the laser vibrometer 106 includes one or more further apertures to receive the reflection. The sensor 114 of the laser vibrometer 106 may include one or more optical detectors (e.g., photodetectors). The optical detector(s) and/or other components of the vibrometer may be configured to generate an output signal or other indication of the intensity of the reflection. The intensity is determinative of whether the laser beam 112 impacts the object 102.

The source 110 and the sensor 114 of the laser vibrometer 106 may be co-located. In this example, the source 110 and the sensor 114 are located within a common housing or enclosure. Both the source 110 and the sensor 114 may use a common aperture, such as the aperture 116, or be otherwise co-located or disposed relative to one another such that the reflection travels along the same line as the laser beam 112 generated by the source 110. The source 110 and sensor 114 may be disposed along a common side of the object 102. With the source 110 and the sensor 114 on the same side, the system 100 need not include a detector or other optical component on the opposite side of the object 102. The proximity of the source 110 and the sensor 114 may be useful, inasmuch as separation (e.g., disposition on opposite sides of the object 102) may undesirably lead to vibration or other relative movement between the source 110 and the sensor 114.

The system 100 includes one or more masks or shields 118 disposed along the object 102. The mask(s) 118 are configured to establish the variation in the reflection intensity. In this example, a single mask 118 has a pair of arms 120 that extend along opposite sides of the blade 104. The arms 120 extend from a base 122 of the mask 118. In other embodiments, tape is used for the mask 118. The mask 118 may be configured to be either reflective or absorptive depending upon the degree to which the object 102 is reflective or absorptive. With reflective objects, the mask 118 is configured to absorb the laser beam 112 when the laser beam 112 does not impact the object 102. As shown in FIG. 1, the arms 120 and the base 122 of the mask 118 may be placed or disposed along and offset from (e.g., under) the edge 108 of the object 102. The mask 118 may include shelves 124 that extend laterally outward from terminal ends of the arms 120. In this example, the shelves 124 extend over adjacent blades 104 of the object 102.

In alternative embodiments, the mask 118 may be reflective. A reflective mask may be useful with other objects, such as those that are not sufficiently reflective (e.g., absorptive). In such cases, the intensity output is indicative of the reflection of the laser beam 112 off of a reflective surface of the mask 118. The intensity drops once the laser beam 112 impacts the object 102 rather than the mask 118. The mask 118 may be placed or disposed along the edge 108 of the object 102, as shown in FIG. 1. Unlike the mask 118 shown in FIG. 1, a reflective mask may include one or more shelves that project inward (rather than extending outward, e.g., over adjacent blades 104 as shown). Such shelves may be configured to pass under the edge 108. The shelves may extend inwardly from arms 120 of the mask 118 and be otherwise similarly configured to the shelves 124 of the mask 118 of FIG. 1. For example, the shelves may have a surface oriented orthogonally to the direction of the laser beam 112. The placement and orientation of such shelves may lead to reflections of the laser beam 112 that are directed directly back to the laser vibrometer 106.

The reflectivity level of the mask 118 may vary. The mask 118 may thus allow the system 100 to accommodate different types of objects with varying levels of reflectivity. The construction, configuration, and other characteristics of the mask 118 may vary accordingly and in other ways. For example, the mask 118 may be constructed to scatter the laser beam 112.

The configuration of the laser vibrometer 106 may vary from the example shown. For example, one or more detectors of the sensor 114 may be spaced from or otherwise not integrated with the source 110 and/or other components of the laser vibrometer 106. The laser vibrometer 106 may alternatively or additionally have any number of optical components for directing the laser beam (or the reflection) also not integrated with the source 110 and/or other components of the laser vibrometer 106. For example, such optical components may include any number of mirrors, splitters, modulators, and/or other devices or components. Such components need not be integrated within a common housing or enclosure to be considered part of the laser vibrometer 106.

The system 100 also includes a positioning system 126 configured to position the object 102 in a location relative to the laser vibrometer 106. In this example, the positioning system 126 moves or positions the object 102 being scanned. The laser vibrometer 106 may thus be disposed in a fixed position. Alternatively, the positioning system 106 may move or position the laser vibrometer 106 (or component(s) thereof) and/or both the laser vibrometer 106 and the object 102. In this embodiment, the positioning system 126 includes a linear stage 128 and a rotary stage 130 to adjust the location or position of the object 102. The linear stage 128 may include a table, plate, or platform that rests on a table, plate, or platform of the rotary stage 130, which, in turn, may be supported by a stationary base (not shown). The configuration of the linear stage 128 and the rotary stage 130 may vary. The positioning system 126 may include any number of linear stages (e.g., for different axes of translation) and any number of rotary stages (e.g., for different axes of rotation) or other stages. In this example, the mask 118 is positioned by the table of the linear stage 128. In other cases, the positioning system 126 may include a separate stage to position the mask 118. One or both of the stages 128 may be configured for multiple axis motion.

The positioning system 126 includes one or more positioners or actuators 132 to drive and control the linear and rotary stages 128, 130. Each positioner 132 may drive a respective one of the stages 128, 130. The configuration of the positioner(s) 132 may vary. For example, the positioner(s) 132 may include a stepper motor or a DC motor with an encoder. The positioner(s) 132 may be integrated with the respective stage to any desired extent.

The positioning system 126 may include one or more position sensors 134 to provide a position output indicative of the relative location of the object 102 and/or laser vibrometer 106 and/or mask 118. The position sensor(s) 134 may directly measure such positions. Alternatively, the position sensor(s) 134 may indirectly measure such positions by detecting the position of a stage or positioner of the positioning system 126. For example, one position sensor 134 may be configured to provide an indication of an angular position of the rotary stage 130 of the positioning system 126.

The positioning system 126 (or a stage or component thereof) may be used to support the object 102 during the edge detection measurements and/or vibration response tests. In the example shown in FIG. 1, the object 102 is mounted on the plate of the linear stage 128. Alternatively, the object 102 is mounted on the plate of the rotary stage 130. In some cases, the stages and/or positioners of the positioning system 126 may disengage or separate from the object 102 after moving the object to a desired location. The configuration or construction of the positioning system 126 may vary to accommodate different test structure sizes, shapes, and complex geometries.

The system 100 includes a controller 136 configured to determine a position of the edge of the object. The controller 136 is coupled to or otherwise in communication with the laser vibrometer 106 (or the sensor 114 thereof) to receive the intensity output and the positioning system 126 (or position sensor(s) 134 thereof) to receive the position output. The position of the edge may be determined by the controller 136 based on the intensity and position outputs, as described below. The controller 136 may also be configured to direct the positioning system 126. For example, the controller 136 may provide data or instructions to the positioning system 126 indicative of a scan grid or other scanning pattern for the measurements.

A processor 138 of the controller 136 may be configured to implement an edge detection routine or other procedure. Instructions or data indicative of the edge detection routine may be stored in a memory 140 of the controller 136. The edge detection procedure may be configured to detect an abrupt change in the intensity of the reflection of the laser beam. In some embodiments, the edge detection procedure is configured as or includes one or more curve fitting procedures. For example, one curve fitting procedure may attempt to fitting a curve (e.g., a line) to a set of intensity data points. The edge detection procedure may then be configured to determine the location of the edge 108 based on the position at which the line (or other curve) crosses a calibration-based reference intensity level. In some embodiments, the rate at which the object is scanned may introduce a delay in the transmission of the intensity output. The edge detection procedure may be accordingly configured with a calibration-based time delay correction routine or other factor to adjust for such delays. Further information regarding exemplary curve fitting and edge detection procedures is provided below.

The controller 136 may also be configured to control the positioning system via one or more positioner control routines. The positioner control routine(s) may be stored in the memory 140 and executed by the processor 138 implementing the edge detection routine. The controller 136 may include any number of processing units (e.g., a computer or a central processing unit thereof) to implement the edge detection routine(s), the positioner control routine(s), and other routines, and any number of memories in which instructions and/or other data are stored.

In some embodiments, the system 100 may be used during vibration testing of the object 102. The system 100 may accordingly include an excitation system 142 configured to apply an excitation force to the object 102 to produce a vibration response in the object 102. The excitation system 142 may be integrated with the other components of the system 100 to any desired extent. For example, the laser vibrometer 106 may be used to measure the vibration response. The relative positioning of the laser vibrometer 106 and the object 102 may be determined (or known) based on the edge location measurements obtained using the laser vibrometer 106. For example, the processor 138 may access the memory 140 to obtain a stored value indicative of the location of the edge 108, and then direct the positioning system 134 to move the object 102 (and/or the vibrometer 106) such that the laser beam 112 impacts the object 102 at a desired location spaced from the edge location (e.g., 5 mm from the edge location).

The system 100 depicted in FIG. 1 may be configured and/or operated during a vibration test as follows. The object 102 is placed on the arrangement of linear and rotary stages 128, 130 of the positioning system 126. Each stage 128, 130 may be equipped or in communication with high precision position sensors. A head of the laser vibrometer 106 is fixed in position. Thus, the position of the measurement laser beam 112 is fixed. The linear and rotary stages 128, 130 are then directed to move the object 102 under the laser beam 112.

The edge(s) 108 of the object 102 are detected during a scan procedure. Each edge position of the object 102 may be discerned as the boundary (e.g., in the direction of the laser beam 112) between two surfaces, a reflective surface and a non-reflective surface. The reflective surface is considered to reflect the laser beam 112 back to the sensor 114 or head of the laser vibrometer 106. The non-reflective surface is considered to not reflect the beam back to the sensor 114 or vibrometer head. Non-reflection may occur for a variety of reasons, including, for example, because the non-reflective surface is obscured by the reflective surface. Surfaces in the proximity of the reflective surface may be masked or covered by the mask 118 or (other non-reflective shield). The mask 118 may improve measurement contrast to detect a point on the object 102 near the edge 108.

The object 102 is moved by the linear and rotary stages 128, 130 while the intensity of the reflected laser beam is measured and the positions of the stages 128, 130 are recorded. The measured intensity is high when the laser beam 112 hits the reflective surface and low when the laser beam 112 hits other surfaces (e.g., the mask 118). The laser intensity signal is then processed and edges are detected based an algorithm or procedure configured to identify sudden jumps or other abrupt changes in the signal intensity (i.e., the intensity of the reflection of the laser beam). An abrupt change indicates a point on the edge 108. The algorithm may use a local fitting of the measured laser intensity and a reference intensity level to select the edge point. The local fitting and/or the reference intensity level may be established through calibration.

Corrections for the time delay in the acquisition of the laser intensity values may be applied. The corrections may also be computed through a calibration procedure, which involves measurements for object movement with very slow speeds. The calibration may also establish the reference intensity level by applying the detection to a point on an edge of known location.

The speed at which the edge 108 is detected may be useful in some applications. As described above, the disclosed embodiments may be configured to achieve a desired detection speed. The detection speed may be set by adjusting the resolution of the grid of scan points. The grid may be made more coarse or refined as desired. The detection speed may alternatively or additionally be adjusted by changing the operational speed of the positioner (e.g., one or more of the stages). A trade-off between accuracy, scan speed, and grid refinement may be made.

With the edge location determined, the object 102 is moved by the rotary and linear stages 128, 130 so that the laser beam 112 points to a desired measurement point defined relative to the measured edges 108 of the object 102. The excitation system 142 may apply an excitation force to the object 102, and the response to the excitation force is measured via the laser vibrometer 106 at the measurement point.

The rotary stage 130 or other rotary architecture of the positioning system 126 may be useful in applications involving the vibration testing of rotary structures or objects, such as the rotating structures used in the turbomachinery industry (e.g., rotors or bladed disks). The rotary architecture may be complementary to the edge detection of such structures. For example, disks of large diameter may be measured with little additional instrumentation or additional fixtures using a rotary architecture. In turbomachinery applications, the desired measurements may be velocities in the direction of the axis of the measured structure (i.e., not in the direction perpendicular to the surface of the structure). In such cases, the test structure may be placed on the positioning system 126 such that its axis is along the axis of the rotary table or stage 130. Hence, the desired measurements are velocities in the direction of the axis of the rotary stage 130. The laser vibrometer 106 may thus provide velocities in the direction of the laser beam 112 (rather than velocities in other directions). Hence, the laser beam 112 is aligned with the axis of the rotary stage 130.

While the systems and methods described herein may be configured for a rotating structure (e.g., a rotor, bladed disks, or other turbomachinery structures), the disclosed embodiments can accommodate a large variety of structures of different geometries and materials. The disclosed embodiments are not limited to turbomachinery or other rotating structures. The disclosed embodiments may be implemented in a variety of other fields.

One embodiment of the edge detection procedure implemented by the controller 136 is described in greater detail. The procedure uses measurements of the variations in the laser intensity signal, S. The laser intensity signal is proportional to the intensity of the reflected beam. The procedure may begin with a scan process in which the laser beam 112 is directed to the mask 118. In this case, the mask 118 is non-reflective. At this point, the laser intensity signal is minimal, S=Sₘᵢₙ. The test structure (or object) 102 is then moved by the linear stage 128 until the laser beam is directed onto the surface of the test structure 102. At that point, the laser intensity is at a maximum, S=Sₘₐₓ. At a certain position of the linear stage 128, the laser beam 112 is partially incident on the mask 118 and partially incident on the edge 108 of the test structure 102.

While the scan process is implemented, both the laser intensity signal and the distance (or position) along the scan line are recorded. For example, the level of the laser intensity signal may be recorded via an 8-bit representation (i.e., 0 to 255). Other representations may be used. Measurement data for multiple scan lines may be obtained in accordance with a predefined grid.

The procedure may be based on the following parameters:

(1) D—the diameter of the laser beam 112 on the test surface, near the edge 108 (e.g., for the Polytec vibrometer referenced above, the laser spot diameter is 37 μm at the standoff distance of 275 mm);

(2) d—the fitting distance, the value of which may be established after a calibration procedure to be d=3.5 D, the calibration procedure using several measurements under distinct conditions (e.g., various scan speeds);

(3) S_{R}—the threshold value of the laser intensity signal, the value of which may be established after a calibration procedure, e.g., S_{R}=(Sₘₐₓ+Sₘᵢₙ)/2;

(4) xₐ—an approximate edge location, which may be determined as the lowest coordinate for which S(xₐ)≧S_{R};

(5) i₁—the index of the measured coordinate nearest x=xₐ−d;

(6) i₂ and i₃—the lowest and highest indexes of the measured coordinates which are fitted by a sloped line and may be determined as described below;

(7) i₄—the index of the measured coordinate nearest x=xₐ+d;

(8) S₁—the value of the laser intensity signal corresponding to the coordinate index i₂; and,

(9) S₂—the value of the laser intensity signal corresponding to the coordinate index i₃.

To determine the position of the edge 108, the laser intensity and position data may be processed as follows. First, the xₐ coordinate is found by detecting the lowest measured coordinate along the scanned line where the laser intensity signal is larger than S_{R}. Then, indexes i₁ and i₄ corresponding to measurements nearest xₐ−d and xₐ+d are identified. The measurements with indexes between i₁ and i₄ are then used in the remainder of the processing steps.

Next, indices i₂ and i₃ are calculated. To find these indices, the best piecewise linear fitting is determined in the following three regions: [i₁ to i₂], [i₂ to i₃], and [i₃ to i₄]. For example, indices i₂ and i₃ are found such that the residual—

$$R = {\sum }_{i = {i}_{1}}^{{i}_{2}} {[ S ( {x}_{i} ) - {S}_{1} ]}^{2} + {\sum }_{i = {i}_{2}}^{{i}_{3}} {[ S ( {x}_{i} ) - \overline{S} ( {x}_{i} ) ]}^{2} + {\sum }_{i = {i}_{3}}^{{i}_{4}} {[ S ( {x}_{i} ) - {S}_{2} ]}^{2}$$

is minimized The averages S₁ and S₂, which are straight horizontal lines, are given by—

$${S}_{1} = \frac{1}{{i}_{2} - {i}_{1} + 1} {\sum }_{i = {i}_{1}}^{{i}_{2}} S ( {x}_{i} ) , , {S}_{2} = \frac{1}{{i}_{4} - {i}_{3} + 1} {\sum }_{i = {i}_{3}}^{{i}_{4}} S ( {x}_{i} ) ,$$

and the linear fitting in the region [i₂ to i₃] is given by—

S̅(xᵢ)=m(xᵢ−xᵢ_{₂})+S₁.

The slope m is that of the line through points A(xᵢ₂,S₁) and B(xᵢ₃,S₂), and is given by—

$$m = \frac{{S}_{2} - {S}_{1}}{{x}_{{i}_{3}} - {x}_{{i}_{2}}}$$

The indexes i₂ and i₃ for which the residual R is minimum are denoted by i₂ * and i₃^{*}, and the signal value for these indices are S₁* and S₂*. The corresponding slope for which the optimal linear fitting takes place is m *. The location xₗ of the edge 108 may then be computed as—

$${x}_{e} = \frac{{S}_{R} - {S}_{1}^{*} + {m}^{*} {x}_{{i}_{2}^{*}}}{{m}^{*}}$$

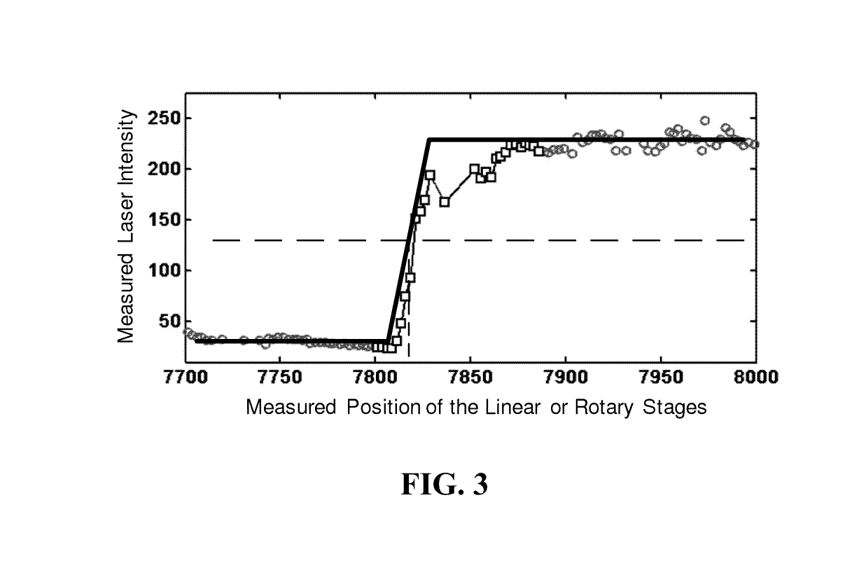

A graphical representation of the above-described processing is shown and described below in connection with FIG. 3. The above-described processing may be implemented via the following exemplary routine:

```
for i₂ =i₁+1 to i₂ =i₄−2 do
      for i₃ =i₂+1 to i₃ =i₄−1 do
            Calculate R
end
end
Choose i₂ and i₃ that correspond with the minimum R [i₂*, i₃* ← i₂,i₃]
Compute the edge location xₑ
```

The controller 136 may include one or more processors 138, such as microprocessors. For example, the controller 136 may include a processor for implementing the edge detection routine and a processor for controlling the positioning system 126. The processor(s) 138 of the controller 136 may be a component of a variety of different computing or other devices or systems. For example, each processor 138 may be part of a standard personal computer or a workstation. The processor(s) 138 may be part of, or include, an electronic instrument (e.g., a field programmable gate array, or FPGA) configured to generate a control signal for the positioning system 126. The processor(s) 138 may be part of, or include, an electronic instrument (e.g., an application-specific integrated circuit, ASIC) configured to receive and process signals from the laser vibrometer 106 and/or the positioning system 126. Such devices and systems may be integrated to any desired extent in one or more general processors, digital signal processors, ASICs, FPGAs, servers, networked computing architectures, digital circuits, analog circuits, combinations thereof, or other now known or later developed devices for analyzing and processing data. The processor(s) 138 may implement one or more software programs. The processor 138 is not limited to a central processing unit (CPU) of a computer.

The memory 140 may be configured for storing instructions and other data in connection with implementing the disclosed embodiments. The instructions stored in the memory 140 may executable by the processor(s) 138 to cause the processor(s) 138 to implement one or more aspects of the excitation procedures. The memory 140 may communicate with the processor(s) 138 via a bus. The memory 140 may be a main memory, a static memory, and/or a dynamic memory. The memory 140 may include a computer readable storage medium, such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. The computer-readable storage medium may be or include a single medium or multiple media, such as a centralized or distributed data store. In one case, the memory may include a cache or random access memory of or for the processor(s). Alternatively or additionally, the memory 140 may be integrated with the processor(s) 138 to any desired extent. The memory 140 may include or be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 140 may include a solid-state memory such as a memory card or other package that houses one or more non-volatile read-only memories. The memory 140 also may be a random access memory or other volatile re-writable memory. Additionally, the memory 140 may include a magneto-optical or optical medium, such as a disk or tapes or other storage device.

The functions, acts or tasks illustrated in the figures or described herein may be performed by the programmed processor 138 executing the instructions stored in the memory 140. The functions, acts or tasks may be independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing and the like.

The controller 136 may further include a display, such as a liquid crystal display (LCD), an organic light emitting diode (OLED), a flat panel display, a solid state display, a cathode ray tube (CRT), a projector, a printer or other now known or later developed display device for outputting determined information. The display may act as an interface for an operator of the excitation system 10 to depict, for example, the operation of the controller 136 (or processor thereof).

The controller 136 may include one or more input devices configured to allow an operator to interact with the controller 136. The input device(s) may be a number pad, a keyboard, touchscreen, or a cursor control device, such as a mouse, or a joystick, touch screen display, remote control or any other device operative to interact with the controller 136.

Dedicated hardware implementations, such as ASICs, programmable logic arrays, and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an ASIC. Accordingly, the present system may encompass software, firmware, and hardware implementations.

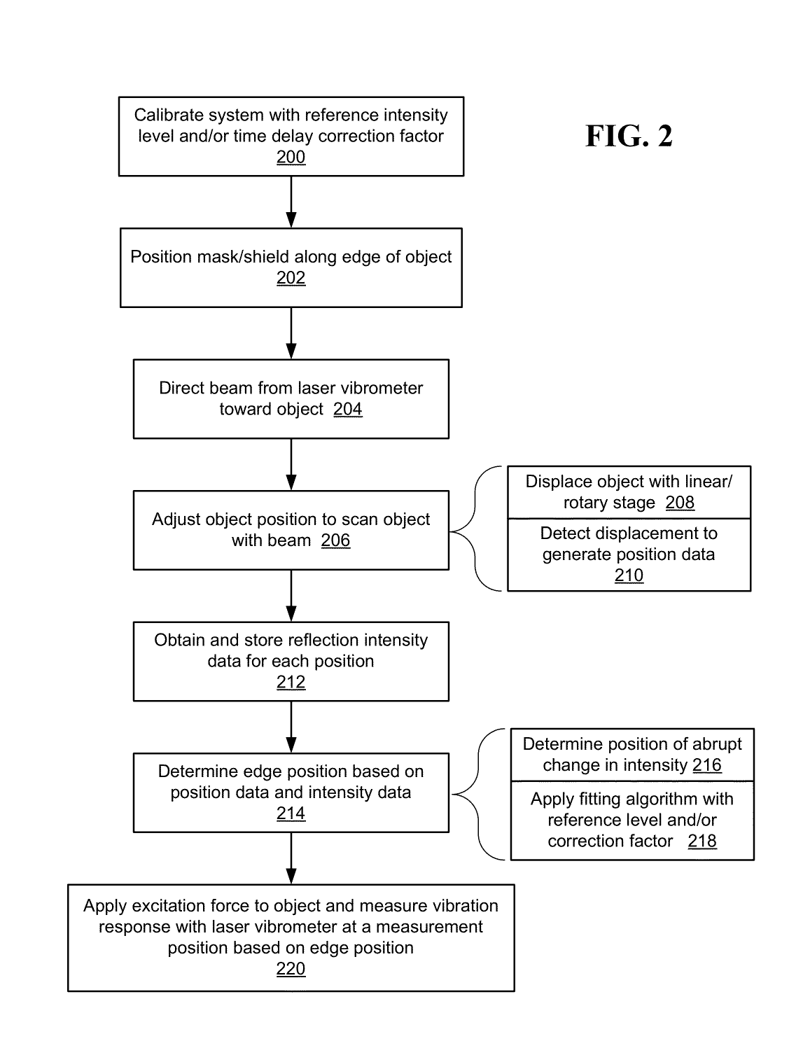

FIG. 2 depicts one example of a method of detecting an edge of an object using a laser vibrometer or other the optical instrument. The method is configured to detect edges via generation of a laser beam, detection of a reflection of the laser beam, and generation of an output indicative of the intensity of the reflection. The method may use an optical emitter or source (e.g., a laser) configured to generate the laser beam, and an optical detector or sensor (e.g., a photodetector) to detect the reflection. The method may be implemented using the above-described system 100 (FIG. 1). One or more of the acts of the method may be implemented by the controller 136 (FIG. 1) or processor 138 (FIG. 1) thereof.

At the outset, one or more calibration routines may be implemented in an act 200. For example, a reference intensity level may be determined to act as a threshold intensity indicative of an edge. Alternatively or additionally, a calibration procedure may be implemented to determine a time delay correction factor, e.g., for a specific scan speed. In some cases, the calibration procedure(s) may include positioning a mask and/or shield along an edge of the object. In other cases, the mask and/or shield may be positioned after completion of the calibration procedure(s).

In the embodiment of FIG. 2, a mask is positioned along an edge of the object in an act 202. For example, the mask may be positioned using a linear stage or other component of a positioning system. Alternatively, the mask may be manually positioned.

A laser beam generated by an optical source of the laser vibrometer is directed in an act 204 toward the object. The laser beam may initially impact the mask, as described above. The position of the object relative to the laser vibrometer is adjusted in an act 206 to scan the object with the laser beam. The relative position adjustment may include movement of the vibrometer and/or the object. The movement may include displacing the object with a linear stage and/or a rotary stage in an act 208. During the movement, the displacement may be detected to generate position data in an act 210.

An intensity of a reflection of the laser beam is then detected or otherwise obtained in an act 212. The reflection intensity may be captured by a sensor of the laser vibrometer. Reflection intensity data may be obtained for a number of positions during the scan. Data indicative of the reflection intensities is stored in one or more memories. The reflection intensity data is obtained and stored during the displacement of the linear stage and/or the rotary stage. Reflection intensity data may be stored for each position of the object. Such scanning, intensity detection, and data storage may be repeated any number of times.

The edge of the object is determined in an act 214 based on the data indicative of the detected intensity and the adjusted position. An edge detection procedure may be implemented in an act 216 in which the point at which an abrupt change in the intensity occurs is determined The procedure may include executing or otherwise applying one or more local fitting algorithms in an act 218, examples of which are provided below.

With one or more positions on the edge of the object known, a vibration test may be implemented in an act 220 in which an excitation force is applied to the object. The object may remain supported by the linear and/or rotary stages of the positioning system during the vibration test. A vibration response to the excitation force is then measured with the laser vibrometer that was used for edge detection. The vibration response measurement is taken at a measurement position on the object based on the determined position of the edge. For example, the measurement position may be selected as a point disposed at a specified distance away from the determined edge position.

The order of the above-described acts may vary from the example shown in FIG. 2. For example, some of the acts may be implemented concurrently either in whole or in part. For instance, the intensity data may be stored while the object position is being adjusted for a subsequent intensity measurement. Additional, fewer or alternative acts may be implemented.

One example of a local curve fitting procedure is now described in connection with FIG. 3. The curve fitting procedure is directed to determining the position at which the intensity, via the curve, reaches a reference intensity level. The nature of the curve may vary from the piecewise linear curve shown in FIG. 3. In this example, the curve includes three lines. Two of the lines are horizontal and correspond with the measured intensity for positions away from the edge (reflection and non-reflection). The third line is sloped to connect the other two lines and thus corresponds with the transition between reflection and non-reflection. The curve fitting procedure may include a determination of the points at which the two horizontal lines intersect the sloped transition line, i.e., the intersection positions. The intersection points are indicated by two dashed lines that specify the edge position and the measured reflection intensity at the edge position.

As described above, the measurement data may be fitted over a distance, d, from the edge position. The fitting distance may be specified via the diameter, D, of the laser beam (e.g., 27 μm). In one example, the fitting distance is 3.5 times the diameter. Thus, the procedure may begin with estimating the edge location, xₐ, based on the reference intensity level and determining the range of positions over which the curve is fit, i.e., between the end positions xₐ−d and xₐ+d. The intensity level measurements may then be indexed between the end positions to support a number of curve fitting computations. The two horizontal lines may include or involve averaging the intensity measurements over the indices between the end positions and the intersection positions. The sloped transition line may then be a line having a slope and y-intercept determined by the intersection positions.

A variety of different regression and other analyses may be implemented to estimate or determine the optimal intersection positions for a given measurement intensity dataset. In one example, an iterative least squares estimation procedure is implemented to find the optimal fitting. The measured intensities are indexed per position. A residual value is defined as the sum of the squares of the offsets (e.g., errors) from the three lines. Thus, each residual value aggregates the errors for the lines given a pair of intersection points. To assign or allocate the intensity measurements to one of the three lines, the residual values may be computed for each possible allocation of indexed intensity measurements. In one example, the residual value computation is iterated for all possible allocations of intensity measurements to the transition line. The transition line in each case may be defined as the sloped line passing through the indexed measurements corresponding with the intersection points. The intersection points that correspond with the minimal residual value may then be determined. With the intersection points, the transition line is defined and the edge location may be determined

With the above-described curve fitting procedure, the edge of an object may be obtained automatically. For example, the system may be configured such that an operator need not select any parameters or control the procedure to determine the edge position.

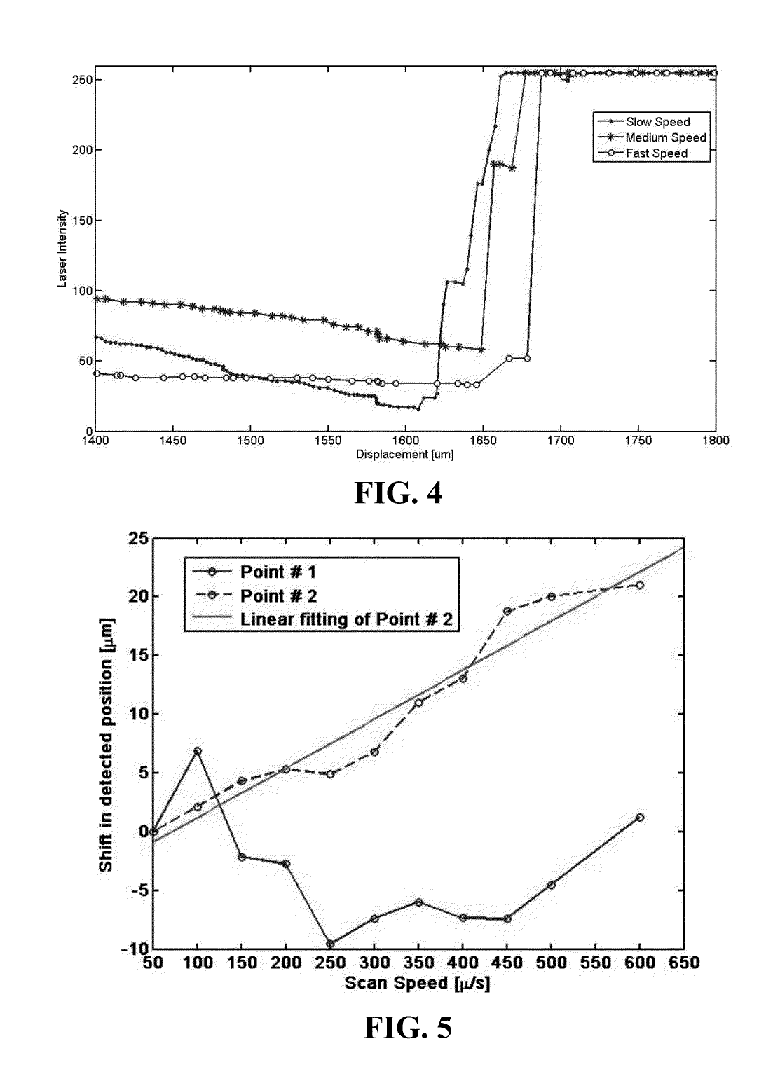

FIG. 4 shows the reflection intensity values as a function of linear stage displacement for three different scanning speeds (slow, medium, fast). The scanning speed is shown to affect the accuracy of the reflection intensity value measurements. The reflection intensity values for the medium and fast scanning speeds may be referenced to the data for the slow scanning speed. Correction factors may be generated for the medium and fast scanning speeds.

FIG. 5 provides further data regarding the shift in reflection intensity values for different scan speeds. The shift is shown for different scan speeds. The mean values of the edge position may be related to the position obtained via the slowest scan speed, which may be considered to be the most accurate. The shift may be considered to be indicative of a time delay in the data processing (e.g., the laser vibrometer processing).

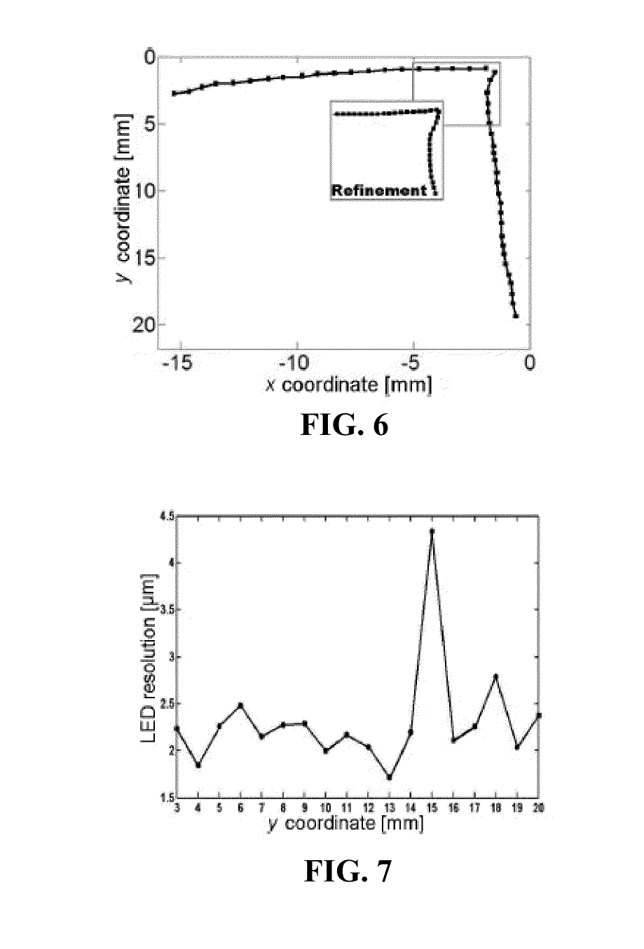

FIG. 6 is a graphical plot that shows a grid of scan locations for a test structure. In one embodiment, a coarse scan is performed using a linear stage (e.g., a 2D linear table) to follow the grid. The coarse scan may be performed first to roughly find where the test structure is positioned with respect to the origin of the linear stage. Then, if higher resolution is desired, a fine scan may be performed for a smaller region of interest, as is shown in the insert of FIG. 6. As described below, one or more of the scan locations shown in FIG. 6 are used to compare the performance of the laser-based edge detection of the disclosed embodiments for different operating parameters, such as time, speed, noise, presence of mask, and laser focus levels.

FIG. 7 is a graphical plot that shows the sensitivity of the edge detection of the disclosed methods and systems to the thickness of the edge of the test structure. The graphical plot also shows the level sensitivity of the laser-based edge detection to the laser focus level at the scanned point. The resolution of measurements collected at 18 edge locations was analyzed. The first edge location has a y coordinate of 3 mm. At this location, the test structure is thinner. The 18th edge location has a y coordinate of 20 mm. At this location the test structure is thicker. The distance from the laser head to the surface of the measured structure varies among all measured edge locations. However, the distance variation is less than 3 mm for all points shown in FIG. 7. Hence, re-focusing the laser is not necessary for collecting vibration data. Nonetheless, some of the 18 edge locations have a better focus than others. The location at they coordinate of 15 mm has the worst focus of all, leading to a higher edge detection resolution at that location. Nevertheless, the resolution is less than 5 μm at all measured edge locations, and as low as 1.72 μm.

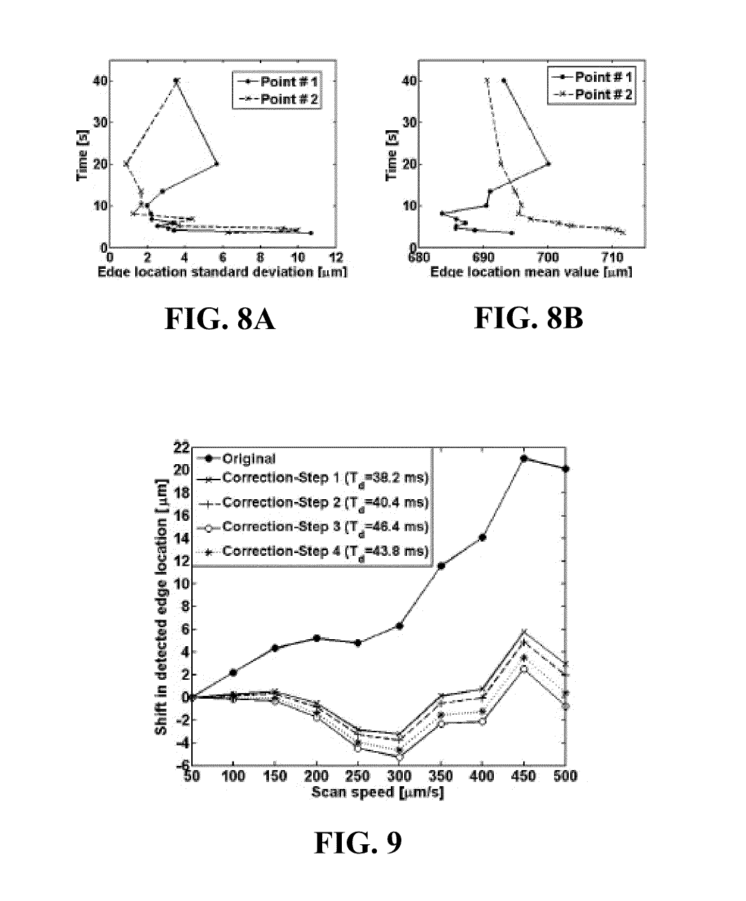

FIGS. 8A and 8B are graphical plots of average edge location and standard deviation, respectively, to show the influence of different operating speeds of the linear stage on the time required for detecting one edge position. A number (i.e., 10) of averages were obtained for two locations along the test structure, labeled as Point #1 and Point #2, for each scan speed. The total scanned distance was 2 mm, which was kept constant. The linear stage was operated consecutively at maximum speeds in the range from 50 μm/sec to 600 μm/sec in increments of 50 μm/sec. The resulting total time required for scanning one edge location is shown on they axis. These results show the trade-off between the time required to detect one edge location and the resolution of the detection.

FIGS. 8A and 8B show that the accuracy of the results may improve at low operating speeds of the linear stage. FIG. 8A shows that the standard deviation of the detected edge location is in the range of ±10 μm for two typical scan points at all of the tested scan speeds. The mean value of the detected edge location for each of the two independent scan locations is shown in FIG. 8B to have a maximum deviation of 25 μm. While the detected edge location shows some fluctuations at high operating speeds, the mean and standard deviation values remain within low limits of repeatability.

FIG. 9 is a graphical plot of a shift in detected edge location as a function of scan speed. The shift in the detected edge location is observed as a function of the operating speed of the linear stage. The shift increases with increased operating speed. Values for the shift plotted in FIG. 9. The mean values of the detected edge location were related to the location obtained at the slowest speed, which was considered to be the most accurate. The shift is indicative of a time delay T_{d} in the laser intensity signal processing. As described above, a correction for the shift may be applied as a calibration. The process was repeated four consecutive times to ensure convergence and stability of the detected time delay T_{d} as shown in FIG. 9.

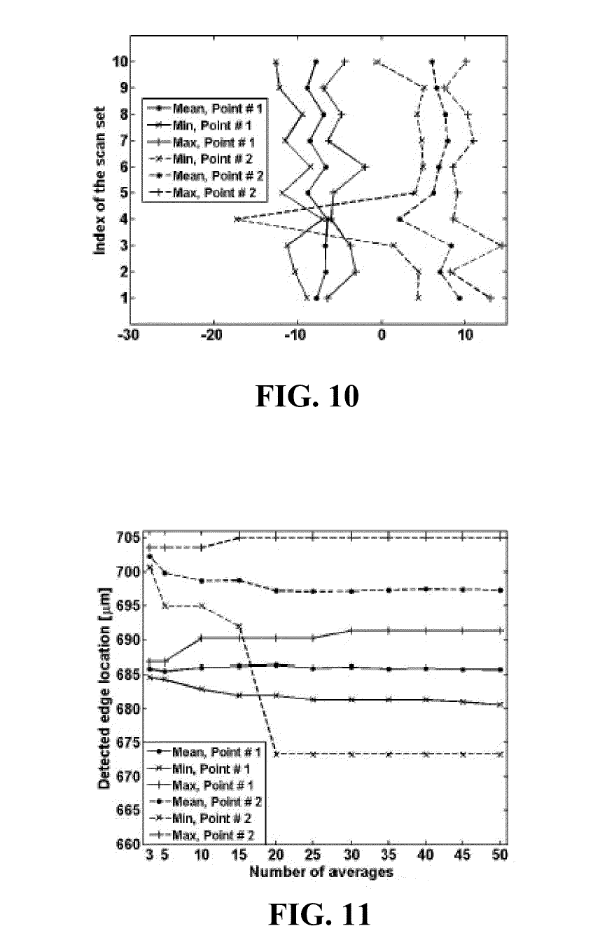

The graphical plots of FIGS. 10 and 11 are directed to depicting the effects of repeated measurements on the predictions of the LED algorithm. Repeating measurements (and averaging) may be used to reduce the effects of measurement noise. However, repeated measurements may be made at the expense of increases in test time. The results in FIGS. 10 and 11 depict the tradeoff between resolution and number of measurements.

FIG. 10 is a graphical plot directed to depicting the mean repeatability of the edge detection techniques of the disclosed embodiments. The mean repeatability is shown to be less than 5 μm. A total of 50 scans were performed for two points (the above-referenced Points #1 and #2). The measurements were divided for each point into 10 scan sets, each of set containing five scans. For each of the 10 scan sets, the minimum, maximum, and mean values of the detected edge location were obtained. The detected edge location for each point was then compared to a reference location for each point. The reference location was a location detected with a scan speed of 50 μm/sec. The deviation from the reference location for Point #1 varied in a range less than 5 μm (namely between -10 μm and −6 μm) for all 10 scan sets. The deviation from the reference location for Point #2 varied in a range less than 10 μm (namely between 1 μm and 10 μm) for all 10 scan sets. Scan set 4 is observed to exhibit the largest fluctuations in the detected edge location. Those fluctuations are likely due to environmental vibrations that occurred during the measurements. The linear stage was operated at a speed of 300 μm/sec in these measurements, and the delay in the laser intensity signal processing was compensated with the value shown in FIG. 10 for that speed.

FIG. 11 is a graphical plot of average edge location to show that the disclosed edge detection methods and systems are stable. Results were obtained for two edge locations (the above-referenced Points #1 and #2) over a number of measurements, the averages of which are shown. The number n of averages is shown on the horizontal axis (with n between 3 and 50). The edge detection with n averages was repeated m times (with m=10). Hence, m average edge locations were obtained for each n. The minimum, maximum, and mean values of these m detected locations are shown on the vertical axis. The mean of the detected edge location varied in a narrow range off 5 μm regardless of whether a minimum of n=3 or a maximum of n=50 averages were used. Although the detected edge location for Point #2 shows fluctuations for n<20 averages, the mean value remained within a range off 5 μm. The linear stage was operated at a speed of 300 μm/sec in these measurements, and the delay in the laser intensity signal processing was compensated with the value shown in FIG. 10 for that speed.

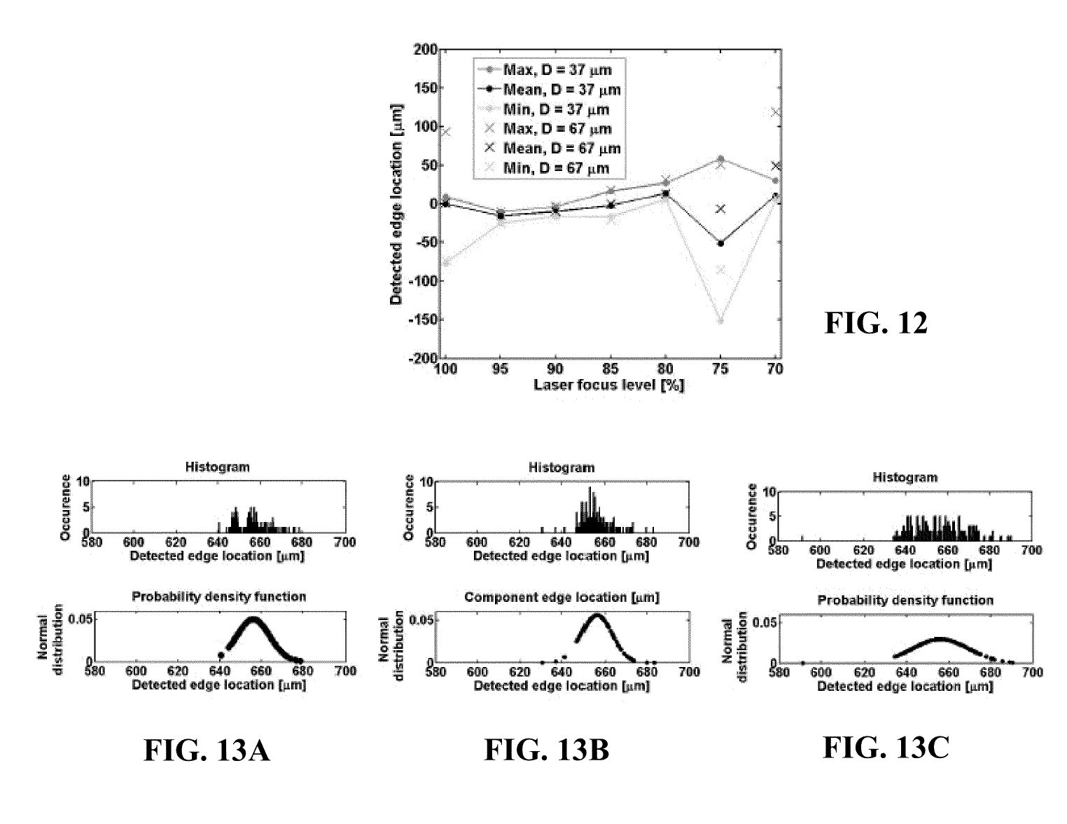

FIG. 12 depicts the influence of the laser focus level and the diameter of the laser beam on the disclosed edge detection methods and systems. A number of (i.e., 100) measurements were collected for the analysis. The minimum, maximum, and mean values of the detected edge location were obtained using two different spot diameters of the laser beam. As shown in the plot, the mean of the detected edge location is centered at 0 irrespective of the laser focus level, with a deviation within a limit of repeatability (e.g., ±5 μm). The results show that spot diameters of about 5 μm to about 100 μm (e.g., about 37 μm) may be useful in some embodiments. A general tradeoff between spot diameter and resolution of detection is presented. The tradeoff results, in part, because the maximum intensity signal generally decreases as the spot diameter increases.

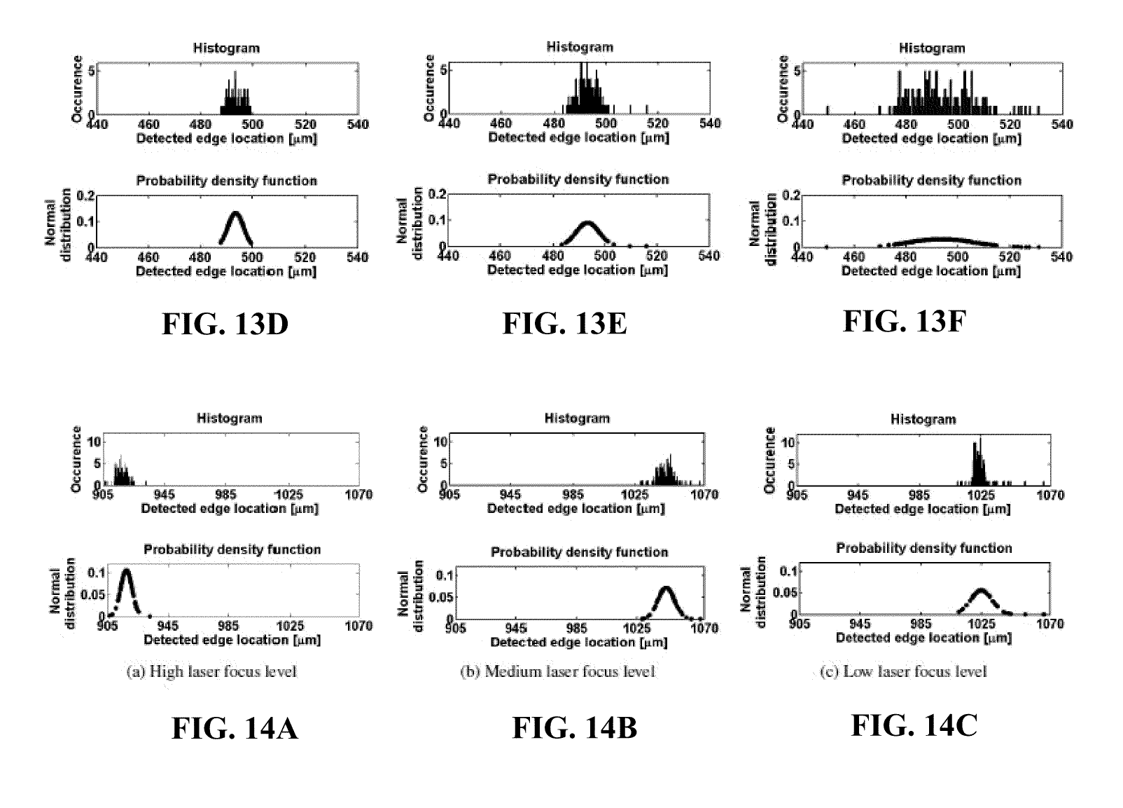

FIGS. 13A-13F present the results of statistical analyses directed to the effects of the adjustment of the speed of the linear stage. For each analysis, two scan points were considered. A number (i.e., 150) of measurements were collected for each scan point. The accuracy of detecting an edge was shown to remain within the limits of repeatability (e.g., ±20 μm) for three different speeds: a low speed at which the linear stage operated at 50 μm/sec (FIGS. 13A and 13D); a medium speed at which the linear stage operated at 300 μm/sec (FIGS. 13B and 13E); and, a fast speed at which the linear stage operated at 500 μm/sec (FIGS. 13C and 13F). The edge detected for each speed was compensated for the delay in the laser intensity signal processing with the corresponding shift shown in FIG. 9. The disclosed edge detection methods and systems may thus be used with the same repeatability for a wide variety of operational speeds of the linear stage.

FIGS. 14A-14C present the results of statistical analyses directed to the influence of different laser focus levels at one edge location along the test structure. A number (i.e., 150) of measurements were collected for each analysis. In FIG. 14A, the maximum laser intensity signal reached was 255 with a mean of 230. In FIG. 14B, the maximum laser intensity signal reached was 230 with a mean of 180. In FIG. 14C, the maximum laser intensity signal reached was 170 with a mean of 130. The same location was measured in each analysis. The shift in the detected edge location observed for different focus levels was due to the optics hardware of the laser beam. First, the laser was focused at its maximum value and the results in FIG. 14A were obtained. Then, the laser was unfocused for the other two analyses (FIGS. 14B and 14C), a situation in which, due to the optics hardware, the orientation of the laser beam changed slightly. That change resulted in a shift in the detected edge location. Nevertheless, the shift does not impact the capability of the laser edge detection procedure to detect edge locations within a narrow limit of repeatability. For all three cases presented in FIG. 19, the laser edge detection procedure predicts the edge location with a repeatability of ±20 μm.

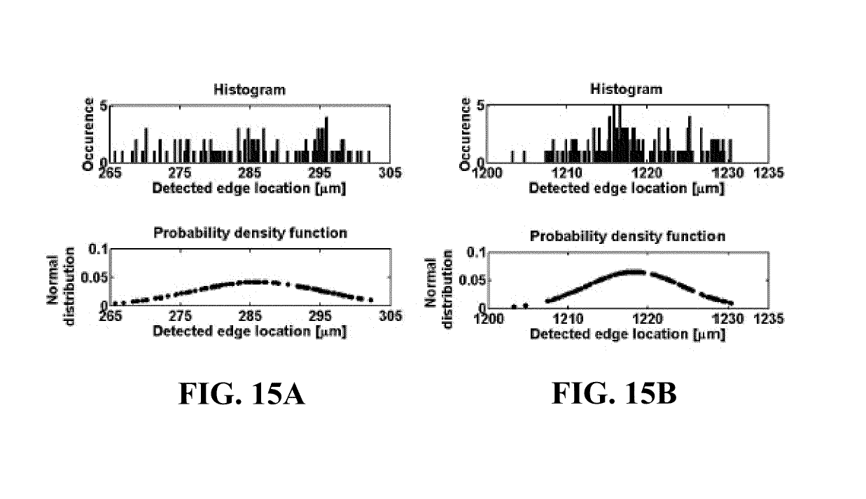

FIGS. 15A and 15B are graphical plots depicting statistical distributions of detected edge locations without the benefit of a mask. FIGS. 15A and 15B present the results of a statistical analysis that demonstrates the performances of the disclosed edge detection methods and systems if a non-reflective mask is not used. The analysis is done at the same two scanned locations as the ones used for FIGS. 13A-13F and 14A-14C. The graphical plots show that, even in the absence of the mask, the edge detection techniques predict the edge location within the limits of repeatability (e.g., ±20 μm).

The disclosed embodiments may be used to determine the vibratory response of structures with complex geometry. These structures may have high modal density, which can result in small changes in structural properties creating large changes in the resonant response. To address this issue, structural properties may be accurately identified, or the structural response may be experimentally measured. Both these approaches involve collecting measurements of higher order vibration modes, which have complicated shape. Consequently, such measurements may involve high accuracy positioning of laser beams from vibrometers based on laser Doppler velocimetry. The disclosed embodiments may be used to provide such high accuracy positioning. The disclosed embodiments may use a single-point or scanning laser vibrometer (e.g., with or without a scanning head), a motion controller, translating/rotating stages, and scan procedure for alignment and edge detection. The beam of the vibrometer may be used for both detecting the edges and for measuring the vibration. Using a motion controller, the system may automatically position, scan, and measure the surface of the test structure with a positioning resolution of, e.g., 1 μm.

The disclosed embodiments may be useful in connection with vibration measurements of a variety of devices and structures. One exemplary application involves bladed disks, which are typically manufactured in one piece, referred to as a blisk or integrally bladed rotor. In the event that a small piece of a blade breaks, the blisk can still be used if the surface of the broken blade is repaired (e.g., smoothed mechanically to remove stress concentrators). Instead of dismantling the engine in which the blisk is installed, the blisk may be repaired in the engine (i.e., on the wing), using a boroscope through one of the inspection holes in the engine casing. The precision of the resulting blended surface is often low. Hence, general blend limits are useful. The disclosed embodiments may then be used to measure the blended disks. The disclosed embodiments may be used to determine the geometry of the edge of the blade, including the blended area. The measurements of the vibration may be done in conjunction (e.g., simultaneously) with an identification (e.g., partial identification) of the blend geometry. The automatic nature of the operation of the disclosed embodiments may also be useful in measuring many bended blisks. Blend limits may be obtained through repeated measurements of different blended blisks.

The methods described herein may be implemented by software programs executable by a computer system. Further, implementations may include distributed processing, component/object distributed processing, and parallel processing. Alternatively or additionally, virtual computer system processing may be constructed to implement one or more of the methods or functionality as described herein.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. A system to detect an edge of an object, the system comprising:
an optical instrument configured to direct a laser beam toward the object, configured to receive a reflection of the laser beam based on whether the laser beam impacts the object, and configured to generate an intensity output indicative of an intensity of the reflection;
a positioning system configured to position the object in a location relative to the optical instrument, the positioning system comprising a position sensor to provide a position output indicative of the location; and
a processor configured to determine a position of the edge of the object based on the intensity output and the position output.

2. The system of claim 1, wherein the intensity output is indicative of the reflection of the laser beam off of a reflective surface of the object.

3. The system of claim 1, further comprising a mask configured for placement along the edge of the object, wherein the intensity output is indicative of the reflection of the laser beam off of a reflective surface of the mask.

4. The system of claim 1, further comprising a shield configured to absorb the laser beam and for placement along the edge of the object, wherein the intensity output is indicative of the reflection of the laser beam off of a reflective surface of the object.

5. The system of claim 1, wherein the processor is configured to implement an edge detection procedure, the edge detection procedure being configured to detect an abrupt change in the intensity of the reflection of the laser beam.

6. The system of claim 5, wherein the edge detection procedure comprises a curve fitting procedure.

7. The system of claim 5, wherein the edge detection procedure is configured with a calibration-based reference intensity level.

8. The system of claim 5, wherein the edge detection procedure is configured with a calibration-based time delay correction factor.

9. The system of claim 1, further comprising an excitation system configured to apply an excitation force to the object to produce a vibration response in the object, wherein the optical instrument comprises a laser vibrometer configured to measure the vibration response.

10. The system of claim 1, wherein the positioning system includes linear and rotary stages to adjust the location.

11. The system of claim 1, wherein the optical instrument comprises a vibrometer configured to receive the reflection of the beam.

12. A method of detecting an edge of an object, the method comprising:
directing a laser beam generated by an optical instrument toward the object;
adjusting a position of the object relative to the optical instrument to scan the object with the laser beam;
detecting an intensity of a reflection of the laser beam; and
determining the edge of the object based on the detected intensity and the adjusted position.

13. The method of claim 12, further comprising positioning a mask along the edge of the object.

14. The method of claim 12, wherein determining the edge of the object comprises implementing an edge detection procedure, the edge detection procedure being configured to detect an abrupt change in the intensity of the reflection of the laser beam.

15. The method of claim 14, wherein implementing the edge detection procedure comprises executing a local fitting algorithm.

16. The method of claim 14, further comprising calibrating the edge detection procedure with a reference intensity level.

17. The method of claim 14, further comprising calibrating the edge detection procedure with a time delay correction factor.

18. The method of claim 12, further comprising:
applying an excitation force to the object; and
measuring a vibration response to the excitation force with a laser vibrometer of the optical instrument at a measurement position on the object based on the determined edge.

19. The method of claim 12, wherein adjusting the position of the object comprises displacing the object with a linear stage or a rotary stage.

20. The method of claim 19, further comprising sensing a displacement of the linear stage or the rotary stage to generate an indication of the position of the object.
